(19) United States
(12) Patent Application Publication
(10) Pub. No.: US 2025/0150515 A1
(43) Pub. Date: May 8, 2025

(54) DATA ACCESS NOTIFICATION

(71) Applicant: Lenovo (Singapore) Pte. Ltd., New Tech Park (SG)

(72) Inventors: Ishan Vaishnavi, München (DE); Emmanouil Pateromichelakis, Viersen (DE)

(21) Appl. No.: 18/837,510

(22) PCT Filed: Mar. 23, 2022
(86) PCT No.: PCT/EP2022/057710

§ 371 Date: Aug. 9, 2024

(30) Foreign Application Priority Data
Feb. 11, 2022 (GR) 20220100133

(51) Int. Cl. H04L 67/55; H04L 12/14; H04W 48/08

(52) U.S. Cl. CPC H04L 67/55; H04L 12/1403; H04W 48/08

(57) ABSTRACT

Apparatuses, methods, and systems are disclosed for data exposure to an authorized entity and data exposure notification. One apparatus includes a transceiver that receives a data access request from an authorized entity and a processor that provides the authorized entity with access to requested data. Via the transceiver, the processor sends an event notification for the data access request to a first entity function, where the event notification indicates an amount of data provided and/or a type of data provided.

### FIELD

The subject matter disclosed herein relates generally to wireless communications and more particularly relates to accounting for data exposure to an authorized entity and data exposure notification.

### BACKGROUND

A telecommunication (“Telco”) network operator possesses a large treasure of data, including data related to the network, users, other networks' data, application level data, data analytics and application data.

### BRIEF SUMMARY

Disclosed are procedures for data exposure to an authorized entity and data exposure notification. Said procedures may be implemented by apparatus, systems, methods, or computer program products.

One method of a Management Services (“MnS”) producer for data exposure to an authorized entity and data exposure notification includes receiving a data access request from an authorized entity and providing the authorized entity with access to requested data. The method includes sending an event notification for the data access request to a first entity, said event notification indicating at least one property selected from the group comprising: an amount of data for which access was provided and a type of data for which access was provided.

One method of a management entity for data exposure to an authorized entity and data exposure notification includes receiving a data management request and sending a data access configuration to a MnS producer entity, said data access configuration including a type of data accessible by external agents and an access reporting configuration. The method includes sending an event notification for the data access request to a first entity, said event notification indicating at least one property selected from the group comprising: an amount of data for which access is provided and a type of data for which access is provided.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for data exposure to an authorized entity and data exposure notification;

FIG. 2A is a diagram illustrating a first embodiment of a Charging Trigger Function (“CTF”) based reporting architecture;

FIG. 2B is a diagram illustrating a second embodiment of a CTF-based reporting architecture;

FIG. 2C is a diagram illustrating a third embodiment of a CTF-based reporting architecture;

FIG. 3 is a call-flow diagram illustrating one embodiment of a procedure for CTF-based accounting of management data access;

FIG. 4A is a diagram illustrating a first embodiment of a Charging Enablement Function (“CEF”) based reporting architecture;

FIG. 4B is a diagram illustrating a second embodiment of a CEF-based reporting architecture;

FIG. 4C is a diagram illustrating a third embodiment of a CEF-based reporting architecture;

FIG. 5A is a call-flow diagram illustrating one embodiment of a procedure for CTF-based accounting of management data access;

FIG. 5B is a continuation of the procedure of FIG. 5A;

FIG. 6 is a block diagram illustrating one embodiment of Management Service instances with various management service components;

FIG. 7A is a block diagram illustrating one embodiment of Management capability exposure governance applied on exposed Management Service;

FIG. 7B is a block diagram illustrating another embodiment of Management capability exposure governance applied on exposed Management Service;

FIG. 8 is a block diagram illustrating one embodiment of a network apparatus that may be used for data exposure to an authorized entity and data exposure notification;

FIG. 9 is a flowchart diagram illustrating one embodiment of a first method for data exposure to an authorized entity and data exposure notification; and

FIG. 10 is a flowchart diagram illustrating one embodiment of a second method for data exposure to an authorized entity and data exposure notification.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for data exposure to an authorized entity and data exposure notification. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A telco network operator possesses a large treasure of data. In the future, a telco network may provide data (anonymized) to multiple other industries. This includes data related to the network, users, other networks' data, application level data, data analytics and application data. Examples of application level data include, but are not limited to, energy consumption or energy availability on a grid or any other network connected to the operator network, such as a Non-Public Network (“NPN,” i.e., a private network). Currently, there is no way for the telco network operator to generate revenue for data access based on the amount and the sensitivity of the data exposed.

Management services from the operator maybe exposed to both: i) entities external to the management domain as well as ii) entities external to the operator network. The current understanding in Third Generation Partnership Project (“3GPP”) Technical Report (“TR”) 28.824 is that the exposure predominantly goes via the Business Support System (“BSS”) unless there is an agreement between the operator and the consumer to directly consume management services. A direct network management level exposure may exist based on customer agreement. An example for this is particularly in cases where one network operator is accessing another network operator's management services to create a federated network (for example, a pan-European network, or an Industry 4.0 operation being federated across multiple sites via the telco network, or a 3GPP core network and RAN network operator utilizing services of an edge network operator).

Using this exposure, management data or application or any data available to the operator could be provided to external entities—for example an energy company may be interested in the amount of energy production on a particular grid, or a vehicle company may be interested in knowing how its vehicles are being used. Other examples include network events, analytics or other data, anonymized use data or processed insights thereof. Currently, there is no way to support a charging model for such data exposure for the network operator in standards.

Accordingly, the below solutions also disclose how to report data access and/or data consumption by authorized third party entities. This reporting may follow a Charging Trigger Function (“CTF”) or Charging Enablement Function (“CEF”) based architecture.

According to a first solution, a Management Services (“MnS”) producer includes/implements a CTF, i.e., it inherently supports charging triggers. In such embodiments, a MnS producer with requested data may generate a Charging Data Record (“CDR”) event notification in response to granting data access to an entity with appropriate authorization.

According to a second solution, a network implements a central CEF to collect data from the MnS producer that may be relevant to one or more charging reports. In such embodiments, the MnS producer with requested data may transmit a data consumption report to the CEF in response to granting data access to an entity with appropriate authorization.

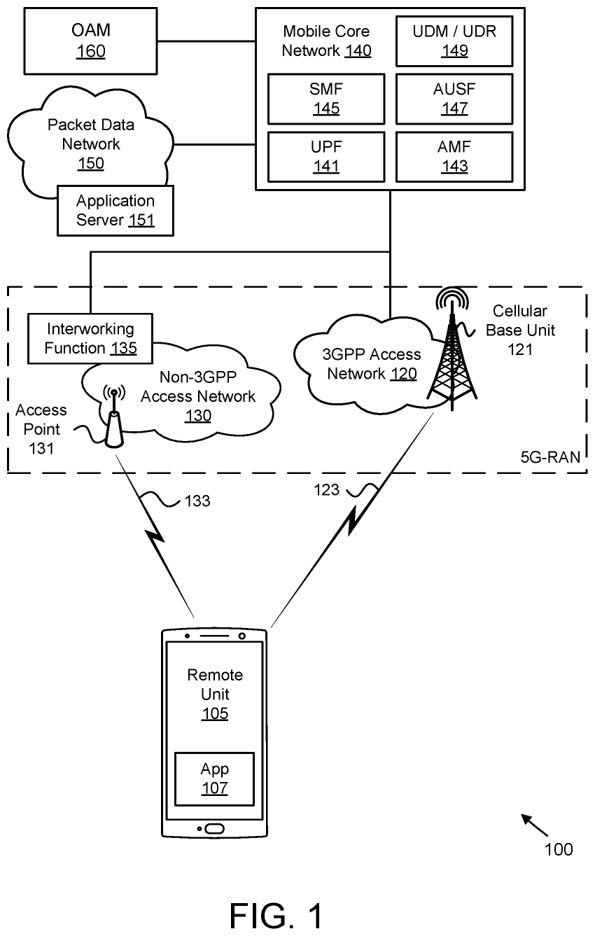

FIG. 1 depicts a wireless communication system 100 for data exposure to an authorized entity and data exposure notification, according to embodiments of the disclosure. In one embodiment, the wireless communication system 100 includes at least one remote unit 105, a 5G Radio Access Network (“5G-RAN”) comprising a Third Generation Partnership Project (“3GPP”) access network 120 and a non-3GPP access network 130, and a mobile core network 140. The 5G-RAN and the mobile core network 140 form a mobile communication network. The 3GPP access network 120 may be composed of a cellular base unit 121 with which the remote unit 105 communicates using wireless communication links 123 and the non-3GPP access network 130 may be composed of an access point 131 with which the remote unit 105 communicates using wireless communication links 133. Even though a specific number of remote units 105, cellular base units 121, wireless communication links 123, access points 131, wireless communication links 133, and mobile core networks 140 are depicted in FIG. 1, one of skill in the art will recognize that any number of remote units 105, cellular base units 121, wireless communication links 123, access points 131, wireless communication links 133, and mobile core networks 140 may be included in the wireless communication system 100.

In one implementation, the 5G-RAN is compliant with the Fifth-Generation (“5G”) cellular system specified in the Third Generation Partnership Project (“3GPP”) specifications. For example, the 3GPP access network 120 may be a Next Generation Radio Access Network (“NG-RAN”), implementing New Radio (“NR”) Radio Access Technology (“RAT”) and/or Long-Term Evolution (“LTE”) RAT. In another implementation, the 5G-RAN is compliant with the LTE system specified in the 3GPP specifications. Moreover, the non-3GPP access network 130 implements a non-3GPP RAT, such as Wi-Fi® or Institute of Electrical and Electronics Engineers (“IEEE”) 802.11-family compliant WLAN. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, a remote unit 105 may be referred to as the User Equipment (“UE”), subscriber unit, mobile, mobile station, mobile device, user, terminal, user terminal, mobile terminal, fixed terminal, subscriber station, wireless transmit/receive unit (“WTRU”), a communication device, or by other terminology used in the art.

In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals, where the UL and DL communication signals are carried over the wireless communication links 123. Furthermore, the UL communication signals may comprise one or more downlink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the 3GPP access network 120 is an intermediate network that provides the remote units 105 with access to the mobile core network 140. Similarly, the remote units 105 may communicate directly with one or more of the access points 131 in the non-3GPP access network 130 via UL and DL communication signals carried over the wireless communication links 133, where the non-3GPP access network 130 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In various embodiments, the remote unit 105 is able to communicate concurrently with both the 3GPP access network 120 and the non-3GPP access network 130. In such embodiments, the remote unit 105 and mobile core network 140 may establish a multi-access connection, such as a Multi Access PDU (“MA PDU”) session, where the multi-access connection comprises a first access path using the 3GPP access network 120 and a second access path in the non-3GPP access network 130. As used herein, an “access path” refers to a user-plane connection using a particular access network and may also be referred to as a “data path” of a multi-access data connection.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The cellular base units 121 may be distributed over a geographic region. In certain embodiments, a cellular base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The cellular base units 121 are generally part of a RAN, such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a service area, for example, a cell or a cell sector, via a wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the cellular base units 121. Note that during NR operation on unlicensed spectrum (referred to as “NR-U”), the cellular base unit 121 and the remote unit 105 communicate over unlicensed (i.e., shared) radio spectrum.

In various embodiments, one or more non-3GPP access networks 130 are distributed over a geographic region, where each non-3GPP access network 130 serves a number of remote units 105 with a service area (also referred to as a coverage area). An access point 131 in a non-3GPP access network 130 may communicate directly with one or more remote units 105 by receiving UL communication signals and transmitting DL communication signals to serve the remote units 105 in the time, frequency, and/or spatial domain. As noted above, both DL and UL communication signals are carried over the wireless communication links 133. In some embodiments, the wireless communication links 123 and the wireless communication links 133 may employ different frequencies and/or different communication protocols. In various embodiments, an access point 131 may communicate using unlicensed (i.e., shared) radio spectrum.

In some embodiments, a non-3GPP access network 130 connects to the mobile core network 140 via an interworking function 135. The interworking function 135 provides interworking between a non-3GPP access network 130 and the mobile core network 140, e.g., supporting connectivity via the “N2” and “N3” interfaces. Note that both the 3GPP access network 120 and the interworking function 135 communicate with the AMF 143 using a “N2” interface and with the UPF 141 using a “N3” interface.

In certain embodiments, a non-3GPP access network 130 may be controlled by an operator of the mobile core network 140 and may have direct access to the mobile core network 140. Such a non-3GPP deployment is referred to as a “trusted non-3GPP access network.” A non-3GPP access network 130 is considered as “trusted” when it is operated by the 3GPP operator, or a trusted partner, and supports certain security features, such as strong air-interface encryption. While the interworking function 135 is depicted as being located outside both the non-3GPP access network 130 and the mobile core network 140, in other embodiments the interworking function 135 may be co-located with the non-3GPP access network 130 (e.g., if the non-3GPP access network 130 is a trusted non-3GPP access network) or located within the mobile core network 140.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the 5G-RAN, a Session Management Function (“SMF”) 145, an Authentication Server Function (“AUSF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The AUSF 147 may act as an authentication server and/or authentication proxy, thereby allowing the AMF 143 to authenticate a remote unit 105. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include additional NFs, such as a Policy Control Function (“PCF”) (e.g., responsible for unified policy framework, providing policy rules to CP functions, access subscription information for policy decisions in UDR), a Network Repository Function (“NRF”) (e.g., which provides Network Function (“NF”) service registration and discovery, enabling NFs to identify appropriate services in one another and communicate with each other over Application Programming Interfaces (“APIs”)), a Network Exposure Function (“NEF”) (e.g., which is responsible for making network data and resources easily accessible to customers and network partners), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. A “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

The wireless communication system 100 includes an operations, administration, and management (“OAM”) platform 160. In various embodiments, the OAM platform 160 performs slice instantiation, e.g., in response to a request from a service provider. The OAM platform 160 may provide network slice configuration parameters to the mobile core network 140 (e.g., to the UDM/UDR 149) indicating which network slices are available in other (e.g., visited) networks. Note that an OAM platform 160 may receive parameters and/or configurations from a Business Support System (“BSS”) and/or an Operations Support System (“OSS”).

The management services for a mobile communication network (with or without network slicing) may be produced by any entity. For example, it can be a Network Functions (“NF”), or network management functions. The entity may provide (i.e., produce) such management services as, for example, the performance management services, configuration management services and fault supervision services. The management services can be consumed by another entity, which may in turn produce (i.e., expose) the service to other entities.

While FIG. 1 depicts components of a 5G RAN and a 5G core network, the described embodiments for data exposure to an authorized entity and data exposure notification apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for data exposure to an authorized entity and data exposure notification.

In various embodiments, a wireless communication network is configured such that the Network Management Layer (“NML”) records chargeable data and periodically reports to the business system for billing. In some embodiments, the reporting is from a performance measurement service producer. In one embodiment, the chargeable data is recorded on a per authentication basis. In another embodiment, the chargeable data is recorded on a per group of authentication basis.

In some embodiments, a network entity may configure the appropriate Management Service (“MnS”) service producer to report the management data or changes thereof to the charging entity. This reporting may follow a Charging Trigger Function (“CTF”) or Charging Enablement Function (“CEF”) based architecture. A key aspect of the following solutions is the type of data that is exchanged.

The reporting data could include any combination of: A) the amount of data accessed, B) details of the data access (e.g., whether it is a subscription to periodic notification, whether data or insights are used, etc.); C) the type management data or other data that is requested: example raw network events such as threshold crossing, handover (“HO”) thresholds configured, processed data (analytics insights), 3^{rd} party data via an NPN network, application-level data such as energy production from a grid site and so forth; D) any management detail, such as the exact Managed Object Instances (“MOIs”), Fully Qualified Domain Names (“FQDNs”), Management Information Base (“MIBs”), and/or Key Performance Indicators (“KPIs”) that are requested; and/or E) the details of the owner of the data

The following embodiments cover the access to an MnS component type C related to a set of MnS components type B, typically via a performance management service. However, the following solutions could further be used to provide 3rd party data related charging—for that the correct performance MnS producer or an alternative data source needs to be used.

According to embodiment of a first solution, the network implements a CTF-based where a MnS producer with requested data reports information relating to charging inherently supports charging triggers—i.e., it can trigger the collection of charging reports in the CHF.

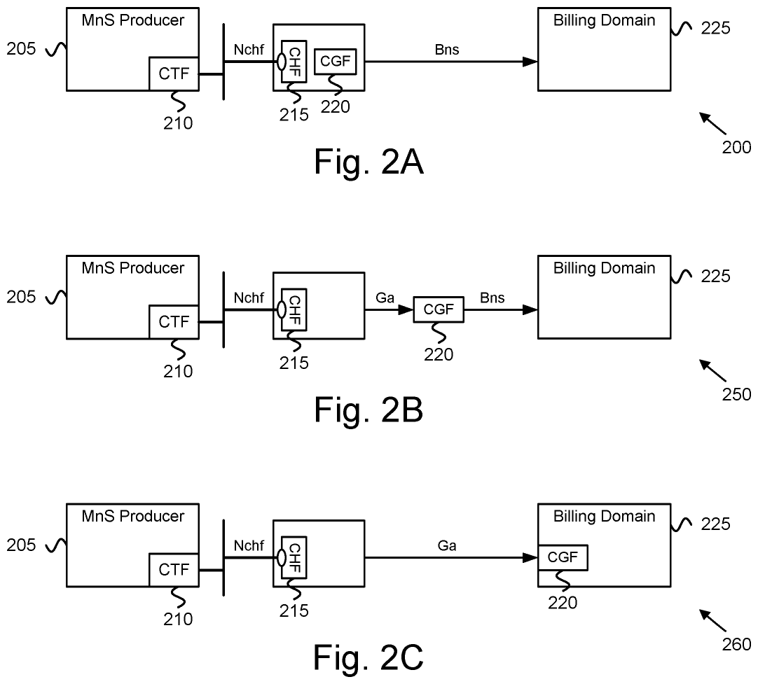

FIGS. 2A-2C depicts different reporting architectures for CTF-based charging/reporting of management data, according to embodiments of the disclosure. Common to the depicted architectures is a MnS producer (e.g., with requested data) that implements a CTF. Different in the depicted architectures is where the Charging Gateway Function (“CGF”) is implemented. A CHF interacts with a billing system via the CGF. In some embodiments, the CGF may process Charging Data Records (“CDRs”) received at the CHF and generate bill files for the billing system. Thus, the CGF may provide interworking between the charging system (i.e., containing the CHF) and the billing system.

FIG. 2A depicts a first architecture 200 having an MnS producer 205 (e.g., a network function or a management function) comprising a CTF instance 210. The architecture 200 uses a service-based architecture (e.g., invoked using standard API), wherein the MnS producer 205 communicates with the CHF 215 using a ‘Nchf’ service-based interface (“SBI”) and the CGF 220 communicates with the billing domain 225 via a ‘Bns’ SBI. In the depicted embodiments, the CHF 215 is part of a converged charging system which also contains the CGF 220. Via the CGF 220, the CHF 215 sends billing data to the billing domain 225.

FIG. 2B depicts a second architecture 250 having an MnS producer 205 (e.g., a network function or a management function) comprising a CTF instance 210. The architecture 250 uses a service-based architecture (e.g., invoked using standard API), wherein the MnS producer 205 communicates with the CHF 215 using a ‘Nchf’ SBI, the charging system (i.e., CHF 215) communicates with the CGF 220 via a ‘Ga’ SBI, and the CGF 220 communicates with the billing domain 225 via a ‘Bns’ interface. In the depicted embodiments, the CGF 220 is an independent entity, e.g., located outside both the charging system (i.e., containing the CHF 215) and also the billing domain. Via the CGF 220, the CHF 215 sends billing data to the billing domain 225.

FIG. 2C depicts a third architecture 260 having an MnS producer 205 (e.g., a network function or a management function) comprising a CTF instance 210. The architecture 260 uses a service-based architecture (e.g., invoked using standard API), wherein the MnS producer 205 communicates with the CHF 215 using a ‘Nchf’ SBI and the charging system (i.e., CHF 215) communicates with the CGF 220 via a ‘Ga’ SBI. In the depicted embodiments, the CHF 215 sends billing data to the CGF 220, which is part of the billing domain 225.

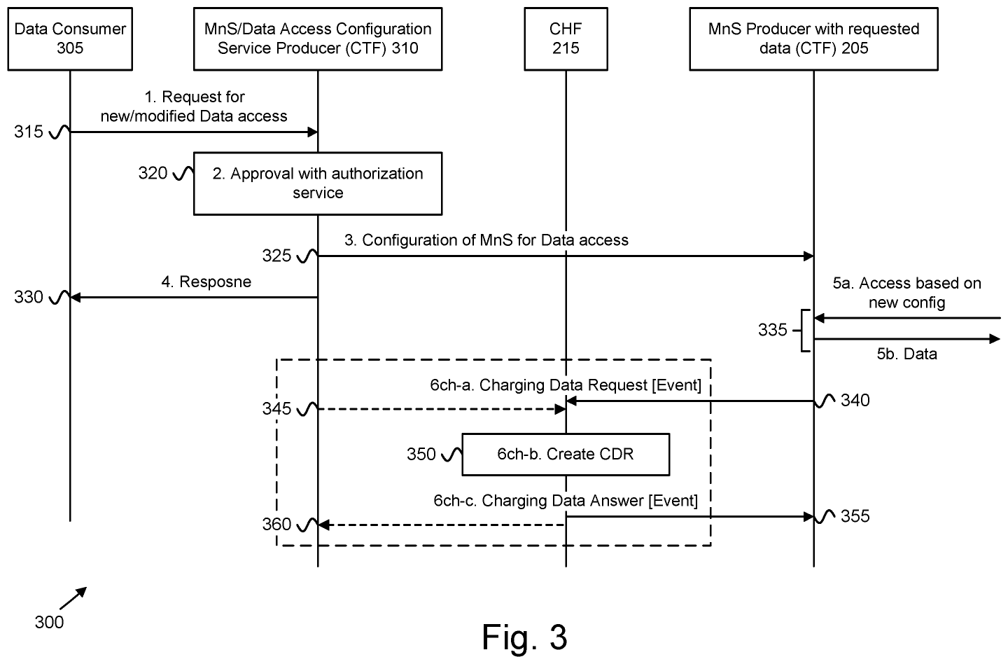

FIG. 3 depicts an exemplary procedure 300 for CTF-based Management Data charging, according to embodiments of the first solution. The procedure 300 involves a data consumer 305, an MnS/data access configuration service producer 310 (for example, a performance management MnS producer or an MnS access config service producer), the CHF 215, and a MnS producer 205 with requested data.

At Step 1, the data consumer 305 (i.e., an authenticated entity) requests new or different management data from the MnS/data access configuration service producer 310 (see messaging 315).

At optional Step 2, the MnS/data access configuration service producer 310 optionally looks for authorization approval from the appropriate authorization entity (see block 320).

At optional Step 3, the MnS/data access configuration service producer 310 may optionally configure the change of access in the appropriate MnS producer (i.e., MnS producer 205 with requested data) for the appropriate data access (see messaging 325). This step includes configuration of the corresponding CTF in the MnS producer 205.

At Step 4, the MnS/data access configuration service producer 310 sends a response to the data consumer 305 indicating success or failure (see messaging 330). In case of success, the MnS/data access configuration service producer 310 may provide additional information, such as: A) approved access the MnS producers' data access, and/or B) information on where to subscribe/send request for accessing MnS data.

At Step 5a, the MnS producer 205 with requested data receives a data access request, e.g., based on the configuration in step 3 (see messaging 335). Here, the data can be requested (and consumed) by an entity with the appropriate authorization (e.g., the data consumer 305). In the depicted embodiment, the MnS producer 205 provides the requested data to the requester. In another embodiment, the MnS producer 205 provides an address of the requested data to the requester.

At Steps 6, a Charging Data Record (“CDR”) event notification is generated by an MnS producer, a CDR is created in the CHF 215, and a reply event is generated. In one embodiment, the CDR event notification is generated by the MnS producer 205 with requested data, e.g., when the data is accessed data is accessed/provided. In another embodiment, the CDR event notification is generated by the MnS/data access configuration service producer 310, e.g., when the new configuration is configured by the performance management service producer.

Specifically, at Step 6ch-a, the MnS producer 205 with requested data sends a charging data request message containing the CDR event notification (see messaging 340). Alternatively, the MnS/data access configuration service producer 310 may send a charging data request message containing the CDR event notification (see messaging 345).

At Step 6ch-b, the CHF 215 creates a CDR (see block 350). The CDR could include one or more of: A) the amount of data; B) the type of data or the change in data; C) the time when the data was recorded—newer data maybe be more valuable than old data; D) indication of whether the data is of a special type (data corresponding to certain events could be more useful); E) an indication of whether user data is included or not; or F) combinations thereof. Note that the accessed data could be of any type and even from another business entity associated to the network operator. For example, the accessed data may correspond to another network or Internet-of-Things (“IoT”) provider in the network, such as energy grid data, IoT data, Vehicle data, etc. The CHF 215 may store this information appropriately subject to local regulations.

At Step 6ch-c, the CHF 215 sends to the MnS producer 205 with requested data a charging data answer message containing the reply event (see messaging 355). Alternatively, the CHF 215 sends the charging data answer message containing the reply event to the MnS/data access configuration service producer 310 (see messaging 360).

In certain embodiments, the CHF 215 in step 6, or later, based on its own policies decide to send the information to the Business Support System (“BSS”) (e.g., billing domain) which then actually uses the CDRs to create to billing information for the account associated to the consumer.

According to embodiments of the second solution, the network implements a CEF-based solution where a centralized function (i.e., CEF entity) collects data that may be relevant to one or more charging reports from a MnS producer with requested data and the CEF may trigger a joint charging data trigger to the CHF.

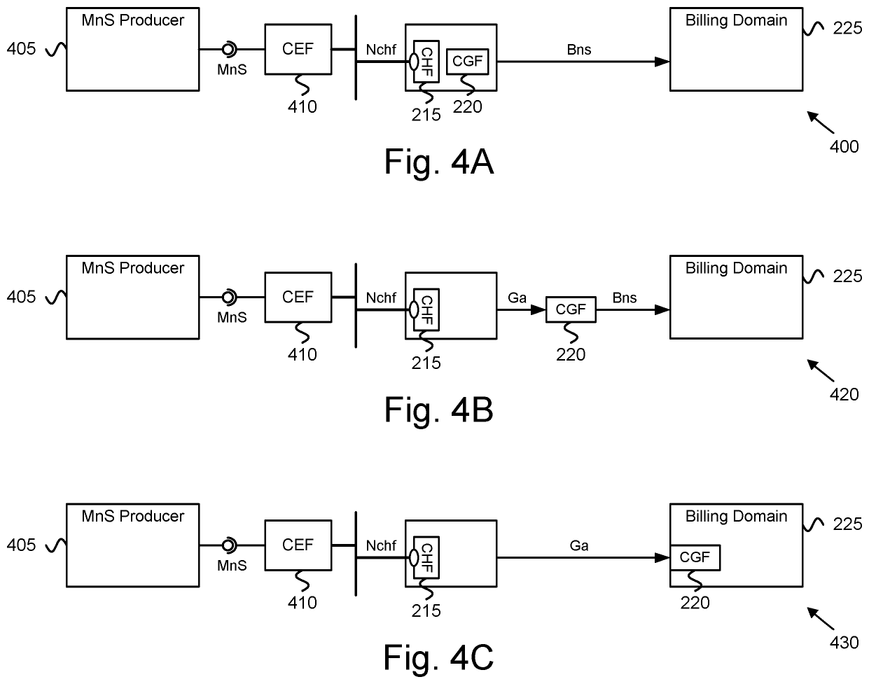

FIGS. 4A-4C depict different reporting architectures for CEF-based charging/reporting of management data, according to embodiments of the disclosure. Common to the depicted architectures is a MnS producer (e.g., with requested data) that interacts with a CEF via a service interface. Different in the depicted architectures is where the Charging Gateway Function (“CGF”) is implemented. A CHF interacts with a billing system via the CGF. In some embodiments, the CGF may process Charging Data Records (“CDRs”) received at the CHF and generate bill files for the billing system. Thus, the CGF may provide interworking between the charging system (i.e., containing the CHF) and the billing system.

FIG. 4A depicts a first architecture 400 having an MnS producer 405 (e.g., a network function or a management function). The architecture 400 uses a service-based architecture (e.g., invoked using standard API), wherein the MnS producer 205 communicates with the CEF 410 via a MnS service interface, the CEF 410 communicates with CHF 215 using a ‘Nchf’ service-based interface (“SBI”), and the CGF 220 communicates with the billing domain 225 via a ‘Bns’ SBI. In the depicted embodiments, the CHF 215 is part of a converged charging system which also contains the CGF 220. Via the CGF 220, the CHF 215 sends billing data to the billing domain 225.

FIG. 4B depicts a second architecture 420 having an MnS producer 405 (e.g., a network function or a management function). The architecture 420 uses a service-based architecture (e.g., invoked using standard API), wherein the MnS producer 205 communicates with the CEF 410 via a MnS service interface, the CEF 410 communicates with CHF 215 using a ‘Nchf’ SBI, the charging system (i.e., CHF 215) communicates with the CGF 220 via a ‘Ga’ SBI, and the CGF 220 communicates with the billing domain 225 via a ‘Bns’ interface. In the depicted embodiments, the CGF 220 is an independent entity, e.g., located outside both the charging system (i.e., containing the CHF 215) and also the billing domain. Via the CGF 220, the CHF 215 sends billing data to the billing domain 225.

FIG. 4C depicts a third architecture 430 having an MnS producer 205 (e.g., a network function or a management function). The architecture 260 uses a service-based architecture (e.g., invoked using standard API), wherein the MnS producer 205 communicates with the CEF 410 via a MnS service interface, the CEF 410 communicates with CHF 215 using a ‘Nchf’ SBI, and the charging system (i.e., CHF 215) communicates with the CGF 220 via a ‘Ga’ SBI. In the depicted embodiments, the CHF 215 sends billing data to the CGF 220, which is part of the billing domain 225.

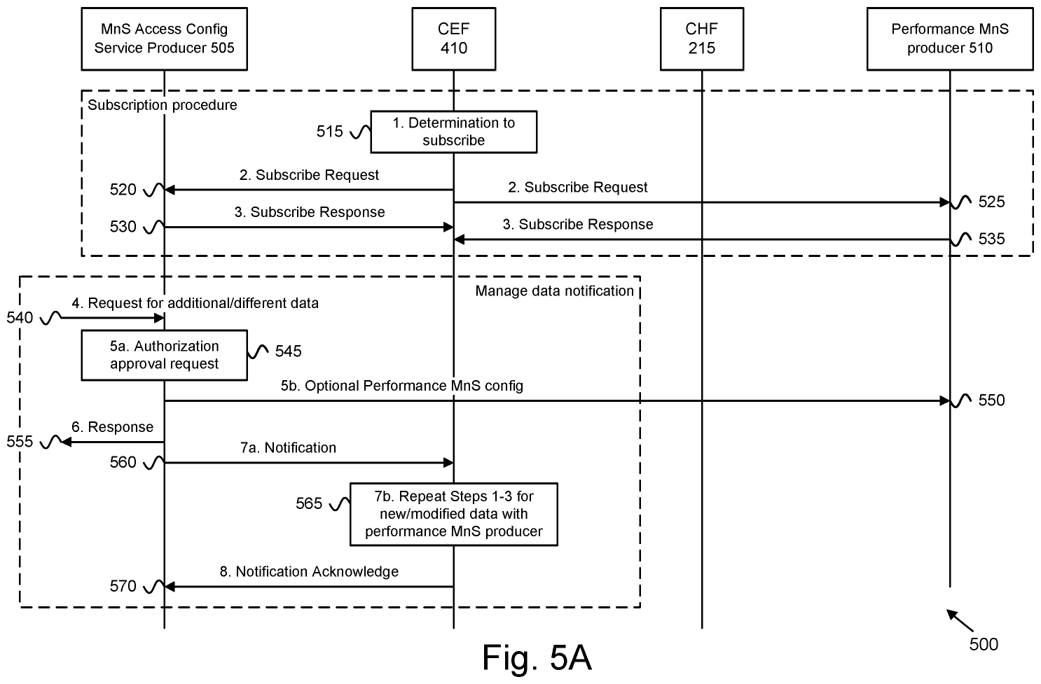

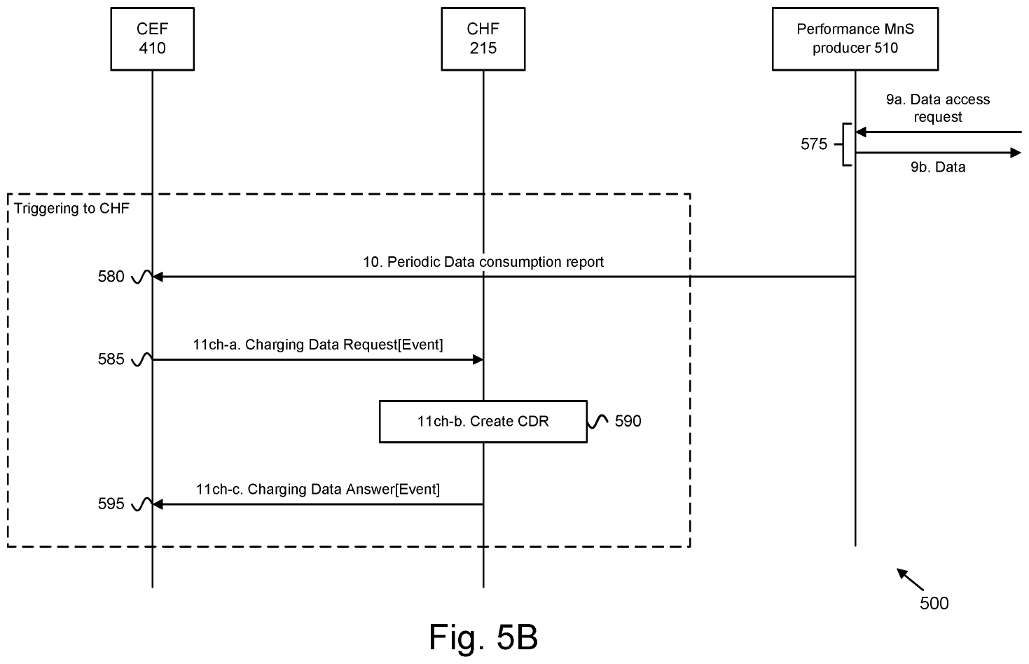

FIGS. 5A-5B depict an exemplary procedure 500 for CEF-based Management Data charging, according to embodiments of the first solution. The procedure 500 involves an MnS access configuration service producer 505 (for example, a performance management MnS producer or an MnS access config service producer or the Exposure Governance Management Function (“EGMF”)), the CEF 410, the CHF 215, and a performance MnS producer 510, e.g., with requested data.

The procedure 500 begins on FIG. 5A, at Step 1 as the CEF 410 determines to subscribe to the MnS access configuration service producer 505 and/or performance MnS producer 510 (see block 515). Note that Steps 1 through 3 represent a subscription phase of the procedure 500. In certain embodiments, the CEF 410 determines to subscribe to the performance MnS producer 510 after receiving a notification from the MnS access configuration service producer 505, as described in greater detail below.

At Step 2, the CEF 410 sends subscribe request messages to the MnS access configuration service producer 505 and performance MnS producer 510 (see messaging 520, 525). In some embodiments, the contents of the subscribe request messages may be as described in 3GPP Technical Specification (“TS”) 28.202.

At Step 3, the CEF 410 received subscribe response messages from the MnS access configuration service producer 505 and performance MnS producer 510 (see messaging 530, 535). In some embodiments, the contents of the subscribe response messages may be as described in 3GPP TS 28.202.

At Step 4, an authenticated entity (e.g., data consumer 305) requests new or different (management) data from the MnS access configuration service producer 505 (see messaging 540). Note that Steps 4 through 8 are a phase for managing data notification.

At optional Step 5a, the MnS access configuration service producer 505 optionally looks for authorization approval from the appropriate authorization entity (see block 545).

At optional Step 5b, the MnS access configuration service producer 505 may optionally configure the change of access to management data in the appropriate MnS producer (e.g., performance MnS producer 510) or corresponding Managed Object Instance (“MOI”) (see messaging 550).

At Step 6, the MnS access configuration service producer 505 sends a response to the authenticated entity (e.g., data consumer 305) indicating success or failure (see messaging 555). In case of success, the MnS access configuration service producer 505 may provide additional information, such as: A) approved access the MnS producers' data access, and/or B) information on where to subscribe for accessing MnS data.

At optional Step 7a, the CEF 410 may receive an optional notification of the new configuration and the corresponding charging (see block 560). In such embodiments, the CEF 410 may trigger the subscription process to the MnS producer (i.e., performance MnS producer 510) which provides the new data (i.e., same as steps 1-3).

At Step 7b, the CEF 410 repeats steps 1-3 above, reflecting the changes in MnS (see block 565).

At Step 8, the CEF 410 sends a notification acknowledgement to the MnS access configuration service producer 505 (see messaging 570).

Continuing on FIG. 5B, at Step 9, the performance MnS producer 510 with the new data receives a data access request, e.g., based on the configuration in step 5b (see messaging 575). Here, the data can be requested (and consumed) by an entity with the appropriate authorization (e.g., the data consumer 305). In the depicted embodiment, the performance MnS producer 510 provides the requested data to the requester. In another embodiment, performance MnS producer 510 provides an address of the requested data to the requester.

At Step 10, the performance MnS producer 510 provides a data consumption report to the CEF 410—indicating, for example, how much and what types of data was accessed (see messaging 580). The report may include one or more of: A) the amount of data; B) the type of data or the change in data; C) the time when the data was recorded—newer data maybe be more valuable than old data; D) indication of whether the data is of a special type (data corresponding to certain events could be more useful); E) an indication of whether user data is included or not; or F) combinations thereof. Note that the accessed data could be of any type and even from another business entity associated to the network operator. For example, the accessed data may correspond to another network or Internet-of-Things (“IoT”) provider in the network, such as energy grid data, IoT data, Vehicle data, etc.

At Steps 11, a CDR event notification is generated by the CEF 410, a CDR is created in the CHF 215, and reply event is generated.

Specifically, at Step 11ch-a, the CEF 410 sends a charging data request message containing the CDR event notification (see messaging 585).

At Step 11ch-b, the CHF 215 creates a CDR (see block 590). The CDR could include one or more of: A) the amount of data; B) the type of data or the change in data; C) the time when the data was recorded—newer data maybe be more valuable than old data; D) indication of whether the data is of a special type (data corresponding to certain events could be more useful); E) an indication of whether user data is included or not; or F) combinations thereof. Note that the accessed data could be of any type and even from another business entity associated to the network operator. For example, the accessed data may correspond to another network or Internet-of-Things (“IoT”) provider in the network, such as energy grid data, IoT data, Vehicle data, etc. The CHF 215 may store this information appropriately subject to local regulations.

At Step 11ch-c, the CHF 215 sends to the MnS producer 205 with requested data a charging data answer message containing the reply event (see messaging 595).

In certain embodiments, the CHF 215 in step 11, or later, based on its own policies decide to send the information to the Business Support System (“BSS”) (e.g., billing domain) which then actually uses the CDRs to create to billing information for the account associated to the consumer.

A Management Service (“MnS”) offers capabilities for management and orchestration of network and service. The entity producing an MnS is called MnS producer. The entity consuming an MnS is called MnS consumer. An MnS provided by an MnS producer can be consumed by any entity with appropriate authorization and authentication.

An MnS producer is described by a set of metadata called ‘MnS producer profile.’ The profile holds information about the supported MnS components and their version numbers. This may also include information about support of optional features. For example, a read operation on a complete subtree of managed object instances may support applying filters on the scoped set of objects as optional feature. In this case the MnS profile should include the information if filtering is supported.

A MnS is composed by a MnS component type A and either 1) a MnS component type B, or 2) both a MnS component type B and a MnS component type C. The instances of management services carry information about specified management service components in the 30 metadata attributes.

A MnS component type A refers to a group of management operations and/or notifications that is agnostic with regard to the entities managed. The operations and notifications as such are hence not involving any information related to the managed network. These operations and notifications are called generic or network agnostic. For example, operations for creating, reading, updating, and deleting managed object instances, where the managed object instance to be manipulated is specified only in the signature of the operation, are generic.

A MnS component type B refers to management information represented by information models representing the managed entities. An MnS component type B is also called Network Resource Model (“NRM”). Examples of an MnS component type B include, but are not limited to, 1) Network resource models (e.g., as defined in 3GPP TS 28.622), and 2) Network resource models (e.g., as defined in 3GPP TS 28.541). In certain embodiments, the MnS component type B is a logical abstraction of the API.

A MnS component type C is performance information of the managed entity and fault information of the managed entity. Examples of an MnS component type C include, but are not limited to, 1) Alarm information (e.g., as defined in 3GPP TS 28.532 and 3GPP TS 28.545), and 2) Performance data (e.g., as defined in 3GPP TS 28.552, 3GPP TS 28.554, and 3GPP TS 32.425).

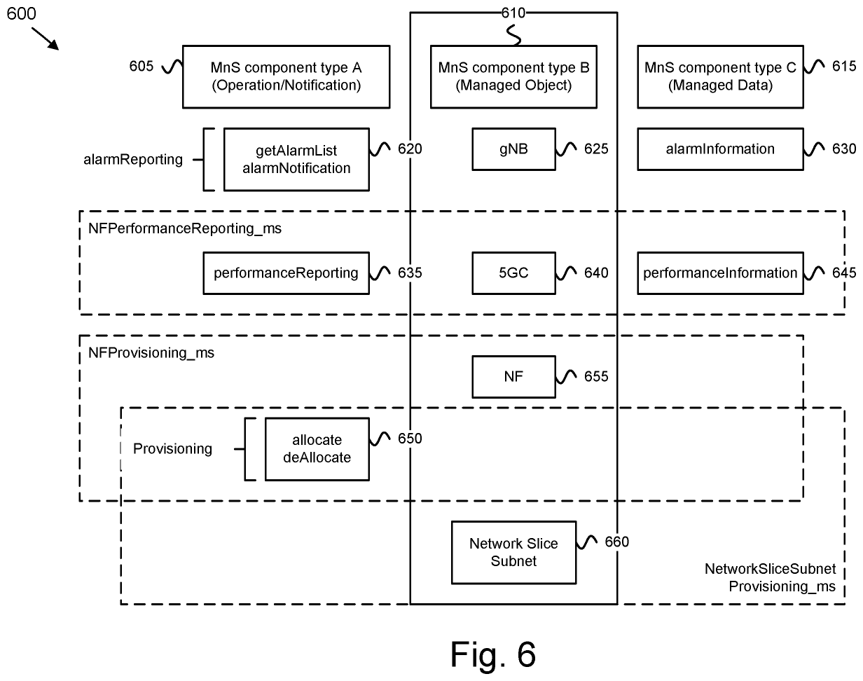

FIG. 6 depicts examples of management service instances with various management service components of type A, type B and type C. As depicted, the MnS component type A 605 corresponds to operation and notification. The MnS component type B 610 corresponds to a managed object, while the MnS component type C 615 corresponds to managed data.

For the case of alarm reporting, the MnS component type A corresponds to the ‘alarmReporting’ operation(s) 620, i.e., ‘getAlarmList’ and/or ‘alarmNotification,’ the MnS component type B corresponds to a gNB 625, and the MnS component type C corresponds to the data ‘alarmInformation’ 630.

For the case of network function performance reporting (i.e., ‘NFPerformanceReporting_ms, the MnS component type A corresponds to the operation ‘performanceReporting’ 635, the MnS component type B corresponds to a 5GC 640, and the MnS component type C corresponds to the data ‘performanceInformation’ 645.

For the case of network function (“NF”) provisioning (i.e., ‘NFProvisioning_ms’), the MnS component type A corresponds to the ‘Provisioning’ operation(s) 650, i.e., ‘allocate’ and/or ‘deAllocate,’ the MnS component type B corresponds to a network function 655. In this example, there is no corresponding MnS component type C.

For the case of network slice subnet instance (“NSSI”) provisioning (i.e., ‘NSSIProvisioning_ms’), the MnS component type A corresponds to the ‘Provisioning’ operation(s) 650, i.e., ‘allocate’ and/or ‘deAllocate,’ the MnS component type B corresponds to a network slice subnet 660. In this example, there is no corresponding MnS component type C.

As precondition for Management Service exposure governance offer, producer of management capability exposure governance should have access to an association between information about specified management service components and instances of management services.

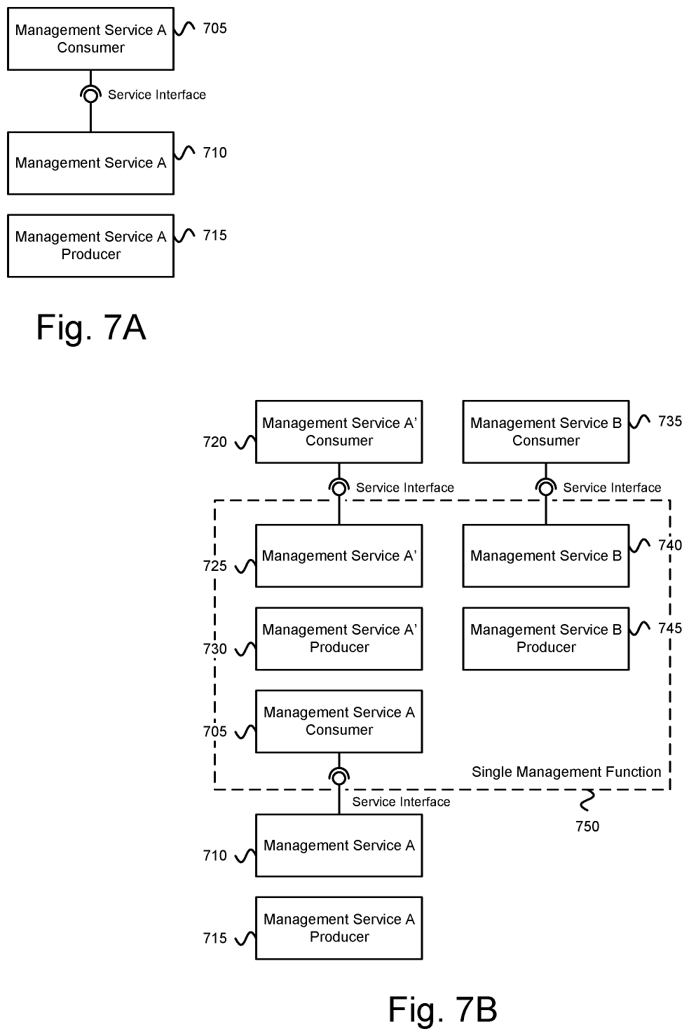

FIGS. 7A-7B depict examples of Management capability exposure governance applied on exposed Management Service, according to embodiments of the disclosure. Management capability exposure governance provides exposure governance on basic elements of management function service based interface: 1) Management service component type A; 2) Management service component type B; and 3) Management service component type C.

FIG. 7A depicts a first scenario of an exposed Management Service A. When there is a Management Service A 710 exposure without exposure governance, the Management Service A Consumer 705 (e.g., 3^{rd} party) can access all management capability offered by Management Service A Producer 715.

FIG. 7B depicts a second scenario of an exposed Management Service A. When Management Service A 710 is exposed with applied exposure governance it becomes Management Service A′ 725. Management Service A′ Consumer 720 can access Management Service A′ 725 after following steps:

Step 1, Management Service A 710, exposed by Management Service A Producer 715, is consumed by Management Service A Consumer 705.

Step 2, Management Service B 740, exposed by Management Service B Producer 745, is consumed by Management Service B Consumer 735 (e.g., operator) who is authorized to access offered management capabilities exposure governance(s).

Step 3, Management Service B Consumer 735 (e.g., operator) requests a specified exposure governance on Management Service A 710.

Step 4, Management Service A′ Producer 730 produces Management Service A′ 725 based on applied exposure governance on consumed Management Service A 710.

The Management Service A Consumer 705, the Management Service A′ Producer 730 and Management Service B Producer 745 can be represented as a single Management Function, e.g., a single Management Function (“MnF”) 750.

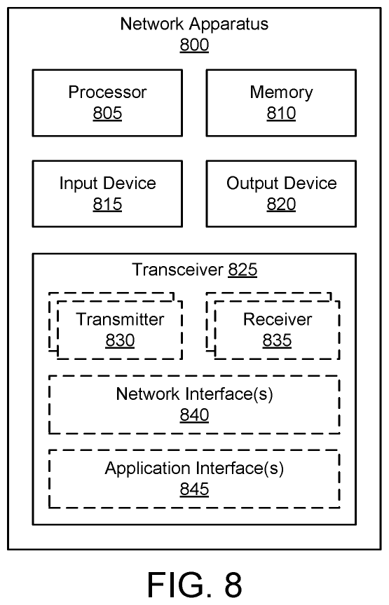

FIG. 8 depicts a network apparatus 800 that may be used for data exposure to an authorized entity and data exposure notification, according to embodiments of the disclosure. In one embodiment, network apparatus 800 may be one implementation of a management services (“MnS”) entity in a mobile communication network, such as the MnS producer 205, the MnS/data access configuration service producer 310, the MnS producer 405, and/or the MnS access configuration service producer 505, as described above. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a Central Processing Unit (“CPU”), a Graphics Processing Unit (“GPU”), an auxiliary processing unit, a Field Programmable Gate Array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above described RAN behaviors. When operating as a RAN node, the processor 805 may include an application processor (also known as “main processor”) which manages application-domain and operating system (“OS”) functions and a baseband processor (also known as “baseband radio processor”) which manages radio functions.

In various embodiments, the network apparatus 800 comprises a MnS Producer that communicates with one or more entities in a mobile communication network (e.g., via a transceiver 825 and/or network interface 840), as described herein. In such embodiments, the processor 805 controls the network apparatus 800 to perform the above described MnS entity behaviors.

In some embodiments, the processor 805 controls the transceiver 825 to receive (e.g., via a network interface 840) a data access request from an authorized entity. The processor 805 provides requested data to the authorized entity and sends (i.e., via the transceiver) an event notification for the data access request to a first entity (e.g., a first network function or first management function). Here, the event notification indicates at least: A) an amount of data for which access was provided and/or B) a type of data for which access was provided.

In some embodiments, the transceiver 825 further receives a data access configuration from a second entity (e.g., from a performance management MnS producer or an MnS access configuration service producer). Here, the data access configuration may indicate a type of data accessible by external agents and an access reporting configuration.

In some embodiments, providing the authorized entity with access to requested data includes delivering the requested data to the authorized entity. In other embodiments, providing the authorized entity with access to requested data includes providing an address corresponding to the requested data to the authorized entity. In some embodiments, the event notification additionally indicates whether the provided data was processed and, if so, indicates an amount of raw data collected for the processing.

In some embodiments, the first entity comprises a CEF. In such embodiments, sending the event notification comprises sending a data consumption report to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

In some embodiments, the processor 805 controls the transceiver 825 to receive (e.g., via a network interface 840) a data management request. The processor 805 sends (i.e., via the transceiver 825) a data access configuration to a MnS data producer entity (i.e., a MnS Producer with data). Here, the data access configuration indicates at least a type of data accessible by external agents and an access reporting configuration. The processor 805 sends (i.e., via the transceiver 825) an event notification for the data access request to a first entity (e.g., a first network function or first management function). Here, the event notification indicates an amount of data for which access is provided and/or a type of data for which access is provided.

In some embodiments, the processor 805 verifies that the data management request is received from an authorized entity prior to sending the data access configuration. In some embodiments, the processor 805 derives the data access configuration from one or more of: an SLA, an SLS, a Service Profile, a Network Slice profile, a GST, or a NEST.

In some embodiments, the first entity comprises a CEF. In such embodiments, sending the event notification comprises sending a notification of the data access configuration and corresponding charging information to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

In some embodiments, the event notification additionally indicates whether the provided data was processed and, if so, indicates an amount of raw data collected for the processing.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to data exposure to an authorized entity and data exposure notification and/or mobile operation. For example, the memory 810 may store parameters, configurations, resource assignments, policies, and the like, as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a liquid-crystal display (“LCD”), an Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with network functions in the Public Land Mobile Network (“PLMN”) and/or RAN, as described herein. Similarly, one or more receivers 835 may be used to communicate with the network functions. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

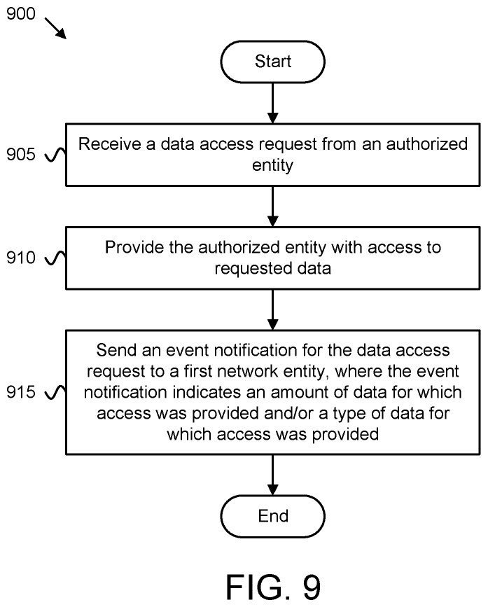

FIG. 9 depicts one embodiment of a method 900 for data exposure to an authorized entity and data exposure notification, according to embodiments of the disclosure. In various embodiments, the method 900 is performed by a reporting entity in a mobile communication network, such as a MnS Producer with data, for instance, the MnS producer 205, the MnS producer 405, and/or the network apparatus 800, as described above. In some embodiments, the method 900 is performed by a processor, such as a microcontroller, a microprocessor, a CPU, a GPU, an auxiliary processing unit, a FPGA, or the like.

The method 900 begins and receives 905 a data access request from an authorized entity. The method 900 includes providing 910 the authorized entity with access to requested data. The method 900 includes sending 915 an event notification for the data access request to a first entity, where the event notification indicates an amount of data for which access was provided and/or a type of data for which access was provided. The method 900 ends.

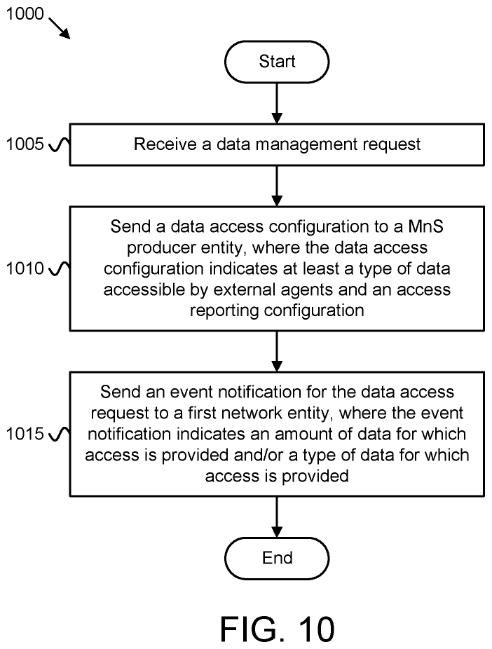

FIG. 10 depicts one embodiment of a method 1000 for data exposure to an authorized entity and data exposure notification, according to embodiments of the disclosure. In various embodiments, the method 1000 is performed by a management entity in a mobile communication network, such as the MnS/data access configuration service producer 310, the MnS access configuration service producer 505, and/or the network apparatus 800, as described above. In some embodiments, the method 1000 is performed by a processor, such as a microcontroller, a microprocessor, a CPU, a GPU, an auxiliary processing unit, a FPGA, or the like.

The method 1000 begins and receives 1005 a data management request. The method 1000 includes sending 1010 a data access configuration to a MnS producer entity, where the data access configuration indicates at least a type of data accessible by external agents and an access reporting configuration. The method 1000 includes sending 1015 an event notification for the data access request to a first entity, where the event notification indicates an amount of data for which access is provided and/or a type of data for which access is provided. The method 1000 ends.

Disclosed herein is a first apparatus for performing signaling exchange (e.g., a registration procedure) with a communication network, according to embodiments of the disclosure. The first apparatus may be implemented by a reporting entity as part of a MnS Producer with data, for instance, the MnS producer 205, the MnS producer 405, and/or the network apparatus 800, described above. The first apparatus includes a receiver (i.e., implementing a network interface) that receives a data access request from an authorized entity. The first apparatus includes a processor that provides requested data to the authorized entity. The first apparatus includes a transmitter that sends an event notification for the data access request to a first entity. Here, the event notification indicates at least: A) an amount of data for which access was provided and/or B) a type of data for which access was provided.

In some embodiments, the transceiver further receives a data access configuration from a second entity (e.g., from a performance management MnS producer or an MnS access configuration service producer). Here, the data access configuration may indicate a type of data accessible by external agents and an access reporting configuration.

In some embodiments, providing the authorized entity with access to requested data includes delivering the requested data to the authorized entity. In other embodiments, providing the authorized entity with access to requested data includes providing an address corresponding to the requested data to the authorized entity. In some embodiments, the event notification additionally indicates that the provided data was processed and indicates an amount of raw data collected for the processing.

In some embodiments, the first entity comprises a CEF. In such embodiments, sending the event notification comprises sending a data consumption report to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

Disclosed herein is a first method for performing signaling exchange (e.g., a registration procedure) with a communication network, according to embodiments of the disclosure. The first method may be performed by a reporting entity as part of a MnS Producer with data, for instance, the MnS producer 205, the MnS producer 405, and/or the network apparatus 800, described above. The first method includes receiving a data access request from an authorized entity and providing the authorized entity with access to requested data. The first method includes sending an event notification for the data access request to a first entity. Here, the event notification indicates at least: A) an amount of data for which access was provided and/or B) a type of data for which access was provided.

In some embodiments, the first method includes receiving a data access configuration from a second entity (e.g., from a performance management MnS producer or an MnS access configuration service producer). Here, the data access configuration may indicate a type of data accessible by external agents and an access reporting configuration.

In some embodiments, providing the authorized entity with access to requested data includes delivering the requested data to the authorized entity. In other embodiments, providing the authorized entity with access to requested data includes providing an address corresponding to the requested data to the authorized entity. In some embodiments, the event notification additionally indicates that the provided data was processed and indicates an amount of raw data collected for the processing.

In some embodiments, the first entity comprises a CEF. In such embodiments, sending the event notification comprises sending a data consumption report to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

Disclosed herein is a second apparatus for data exposure to an authorized entity and data exposure notification, according to embodiments of the disclosure. The second apparatus may be implemented by a management entity in a mobile communication network, such as the MnS/data access configuration service producer 310, the MnS access configuration service producer 505, and/or the network apparatus 800, described above. The second apparatus includes a receiver (i.e., implementing a network interface) that receives a data management request. The second apparatus includes a processor that creates a data access configuration comprising a type of data accessible by external agents and an access reporting configuration. The first apparatus comprises a transmitter (i.e., implementing a network interface) that sends the data access configuration to a MnS data producer entity (i.e., a MnS Producer with data) and sends an event notification for the data access request to a first entity. Here, the event notification indicates an amount of data for which access is provided and/or a type of data for which access is provided.

In some embodiments, the processor verifies that the data management request is received from an authorized entity prior to sending the data access configuration. In some embodiments, the processor derives the data access configuration from one or more of: an SLA, an SLS, a Service Profile, a Network Slice profile, a GST, or a NEST.

In some embodiments, the first entity comprises a CEF. In such embodiments, sending the event notification comprises sending a notification of the data access configuration and corresponding charging information to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

In some embodiments, the event notification additionally indicates that the provided data was processed and may additionally indicate an amount of raw data collected for the processing.

Disclosed herein is a second method for data exposure to an authorized entity and data exposure notification, according to embodiments of the disclosure. The second method may be performed by a management entity in a mobile communication network, such as the MnS/data access configuration service producer 310, the MnS access configuration service producer 505, and/or the network apparatus 800, described above. The second method includes receiving a data management request and sending a data access configuration to a MnS data producer entity (i.e., a MnS Producer with data). Here, the data access configuration indicates at least a type of data accessible by external agents and an access reporting configuration. The second method includes sending an event notification for the data access request to a first entity. Here, the event notification indicates an amount of data for which access is provided and/or a type of data for which access is provided.

In some embodiments, the second method includes verifying that the data management request is received from an authorized entity prior to sending the data access configuration. In some embodiments, the second method includes deriving the data access configuration from one or more of: an SLA, an SLS, a Service Profile, a Network Slice profile, a GST, or a NEST.

In some embodiments, the first entity comprises a CEF. In such embodiments, sending the event notification comprises sending a notification of the data access configuration and corresponding charging information to the CEF. In other embodiments, the first entity comprises a CHF. In such embodiments, sending the event notification includes sending a charging data request to the CHF. In certain embodiments, the CHF is configured to collect and report overall charging parameters to a business system for evaluation of the final charge.

In some embodiments, the event notification contains information relating to the accessed data. In certain embodiments, the information relating to the accessed data includes one or more of: A) an age of the data that was accessed (i.e., the time when the data was recorded); B) an owner of the data that was accessed; C) an indication of whether the accessed data was of a special type; D) an indication of whether user data was accessed; E) a set of users related to the data that was accessed; F) a geographical area related to the data that was accessed; G) an indication of what other data the authorized entity has access to; H) an indication of the identity of the authorized entity; or I) some combination thereof.

In some embodiments, the event notification additionally indicates that the provided data was processed and may additionally indicate an amount of raw data collected for the processing.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising a management services (“MnS”) reporting entity, the apparatus comprising:
at least one memory; and
at least one processor coupled with the at least one memory and configured to cause the MnS reporting entity to:
receive a data access request from an authorized entity;
provide the authorized entity with access to requested data; and
transmit an event notification for the data access request to a first entity, the event notification indicating at least one property selected from the group comprising:
an amount of data for which access was provided; and
a type of data for which access was provided.

2. The apparatus of claim 1, wherein the at least one processor is configured to cause the MnS entity to receive, from a second entity, a data access configuration indicating a type of data accessible by external agents and an access reporting configuration.

3. The apparatus of claim 1, wherein to provide authorized entity with access to requested data, the at least one processor is configured to cause the MnS entity to:
transmit the requested data to the authorized entity; or
provide an address corresponding to the requested data to the authorized entity.

4. The apparatus of claim 1, wherein the first entity comprises a charging function (“CHF”), and wherein to transmit the event notification, the at least one processor is configured to cause the MnS entity to transmit a charging data request to the CHF.

5. The apparatus of claim 1, wherein the first entity comprises a charging enablement function (“CEF”), and wherein to transmit the event notification, the at least one processor is configured to cause the MnS entity to transmit a data consumption report to the CEF.

6. The apparatus of claim 1, wherein the event notification comprises information relating to the accessed data, the information comprising:
an age of the data that was accessed;
an owner of the data that was accessed;
an indication of whether the accessed data was of a special type;
an indication of whether user data was accessed;
a set of users related to the data that was accessed;
a geographical area related to the data that was accessed;
an indication of what other data the authorized entity has access to;
an indication of an identity of the authorized entity;
or a combination thereof.

7. The apparatus of claim 1, wherein the event notification additionally indicates that the accessed data was processed and may additionally indicate an amount of raw data collected for the processing.

8. A method performed by a management services (“MnS”) entity, the method comprising:
receiving a data access request from an authorized entity;
providing requested data to the authorized entity; and
transmitting an event notification for the data access request to a first entity, the event notification indicating at least one property selected from the group comprising:
an amount of data provided; and
a type of data provided.

9. A management apparatus comprising:
at least one memory; and
at least one processor coupled with the at least one memory and configured to cause the management apparatus to:
receive a data management request;
create a data access configuration comprising a type of data accessible by external agents and an access reporting configuration; and
transmit the data access configuration to a MnS data producing entity; and
transmit an event notification for the data access request to a first entity, the event notification indicating at least one property selected from the group comprising:
an amount of data provided; and
a type of data provided.

10. The management apparatus of claim 9, wherein the at least one processor is configured to cause the management apparatus to verify that the data management request is received from an authorized entity prior to the transceiver sending the data access configuration.

11. The management apparatus of claim 9, wherein the at least one processor is configured to cause the management apparatus to derive the data access configuration from one or more of: a Service level agreement (“SLA”), a Service level specification (“SLS”), a Service Profile, a Network Slice profile, a Generic network Slice Template (“GST”), or a network slice template (“NEST”).

12. The management apparatus of claim 9, wherein the first entity comprises a charging function (“CHF”), wherein to transmit the event notification, the at least one processor is configured to cause the management apparatus to transmit s a charging data request to the CHF.

13. The management apparatus of claim 9, wherein the first entity comprises a charging enablement function (“CEF”), wherein to transmit the event notification, the at least one processor is configured to cause the management apparatus to transmit a notification of the data access configuration and corresponding charging information to the CEF.

14. The management apparatus of claim 9, wherein the event notification comprises information relating to the accessed data, the information comprising:
an age of the data that was accessed;
an owner of the data that was accessed;
an indication of whether the accessed data was of a special type;
an indication of whether user data was accessed;
or a combination thereof.

15. The management apparatus of claim 9, wherein the event notification additionally indicates that the accessed data was processed and indicates an amount of raw data collected for the processing.

16. A method performed by a management entity, the method comprising:
receiving a data management request;
creating a data access configuration comprising a type of data accessible by external agents and an access reporting configuration;
transmitting the data access configuration to a MnS data producing entity; and
transmitting an event notification for the data access request to a first entity, the event notification indicating at least one property selected from the group comprising:
an amount of data provided; and
a type of data provided.

17. The method of claim 16, further comprising verifying that the data management request is received from an authorized entity prior to the transceiver sending the data access configuration.

18. The method of claim 16, further comprising deriving the data access configuration from one or more of: a Service level agreement (“SLA”), a Service level specification (“SLS”), a Service Profile, a Network Slice profile, a Generic network Slice Template (“GST”), or a network slice template (“NEST”).

19. The method of claim 16, wherein the first entity comprises a charging function (“CHF”), wherein transmitting the event notification comprises transmitting a charging data request to the CHF.

20. The method of claim 16, wherein the first entity comprises a charging enablement function (“CEF”), wherein transmitting the event notification comprises transmitting a notification of the data access configuration and corresponding charging information to the CEF.
